(19) United States
(12) Patent Application Publication
(10) Pub. No.: US 2003/0053904 A1
(43) Pub. Date: Mar. 20, 2003

(54) Wafer aligner

(76) Inventors: Naofumi Kirihata, Bisai-shi (JP); Jun Yoshida, Bisai-shi (JP)

Correspondence Address: David T. Nikaido, RADER, FISHMAN & GRAUER, PLLC, Suite 501, 1233 20th Street, NW, Washington, DC, 20036, US

(21) Appl. No.: 10/237,078

(22) Filed: Sep. 9, 2002

(30) Foreign Application Priority Data
Sep. 14, 2001 (JP) 2001-279693
Sep. 21, 2001 (JP) 2001-289979
Jun. 28, 2002 (JP) 2002--190746

(51) Int. Cl. B65G 49/07

(52) U.S. Cl. 414/783; 414/936; 414/941

(57) ABSTRACT

In order to detect the position of notch or orientation flat during high speed rotation while preventing deviation of position of a wafer by gripping the wafer securely, an aligner 1 comprises a machine bed 10, a transfer arm 20 of a water 3, and a holding clamper 30. The holding clamper 30 has upper arms 33, 34, 35, and is designed to grip the wafer 3 securely, and is elevatable by means of an elevating drive unit 15, and is also movable in the horizontal direction of the upper arm 3 by means of an opening drive unit 16. Accordingly, the wafer 3 put on the transfer arm 20 is gripped by the holding clamper 30 and rotated by one revolution, so that the position of the notch is detected by a detector, and the notch is moved to the reference rotation position. Further, en engaging pawl is disposed in the upper arm 33, and when gripping the wafer 3, the engaging pawl can be engaged with the notch of the wafer 3.

### BACKGROUND OF THE INVENTION

(1) Field of the Invention

The present invention relates to a wafer aligner suitable for detecting the notch or orientation flat of a wafer large in size, and more particularly to an improvement of a wafer aligner for positioning the wafer more precisely.

(2) Description of the Prior Art

As known well, a silicon wafer is provided with a mark indicating the reference rotation position in the circumferential direction of wafer, such as an orientation flat cut like a chord or a notch cut in V or U shape, formed on the outer circumference. When forming gates of semiconductor or the like on wafers, it has been required that the individual wafers should be set on the processing stage always in a state of coincidence between the position of the orientation flat or notch and the reference rotation position.

A cassette accommodates a plurality of wafers usually in a random state as being arranged in the vertical direction. Therefore if a wafer is taken out from the cassette by a conveying robot and directly set on the processing stage, the wafer is put on the processing stage while the position of the orientation flat or notch does not coincide with the reference rotation position, and the wafer cannot be processed as desired.

Accordingly, the wafer taken out of the cassette was once put into the orientation flat matching device or wafer aligner, and the position of the notch or orientation flat was set to coincide with the reference rotation position by the orientation flat matching device or wafer aligner, then the wafer was set on the processing stage.

A conventional wafer aligner was designed to support the wafer by sucking the reverse side of the wafer, or drop the wafer to support the outer circumference of the reverse side of the wafer. For example, in the case of a wafer aligner 50 shown in FIG. 1, a fixed stage 51 having a holder 52a for supporting the outer circumference of the wafer 3, and a rotary stage 53 disposed beneath the fixed stage 51, being movable vertically and rotatable are disposed on a machine bed 55 (see Japanese Laid-open Patent No. 2000-21956).

The fixed stage 51 has three arms 52 extended at equal intervals from the rotation center position, and is formed to hold the wafer 3 held by the robot hand by lowering from the upward position of the holder 52a by the descending move of the hand, whereas the rotary stage 53 has three arms 54 extended at equal intervals from the rotation center position, and is designed to lift the wafer 3 supported on the fixed stage 51, rotate one revolution, and detect the notch or orientation flat position.

However, when supporting by sucking the reverse side of the wafer, the wafer reverse side may be injured or waste particles may stick, and hence there was a tendency of avoiding suction of the reverse side of the wafer. Besides, in the conventional wafer aligner 50 disclosed in the publication, although injury of wafer 3 or generation of waste particle is minimized by supporting the outer circumference of the reverse side of the wafer 3, since the wafer 3 is supported in the guide of the rotary stage 53 by dropping, the outer circumference of the wafer 3 is not held as being pressed by the guide. Accordingly, when the wafer 3 is rotated in order to detect the position of the notch or orientation flat, slipping occurs between the outer circumference of the wafer 3 and the holder 54a of the arm 54 of the rotary stage 53, and the precision of the rotating direction cannot be assured. To assure the precision, it is hence required to drive at a speed not to cause slipping, and high speed rotation is limited. Still more, since there is a slight gap between the outer circumference of the wafer 3 and the guide 54b of the arm 54, the positioning precision is lowered not only in the rotating direction, but also in the X-axis or Y-axis direction.

### SUMMARY OF THE INVENTION

The present invention is intended to solve the above problems, and it is hence an object thereof to present a wafer aligner capable of enhancing the positioning precision by securely gripping the edge of a wafer, and detecting the position of the notch or orientation flat by rotating at high speed, without injuring the wafer or generating waste particles.

To solve the problems, the wafer aligner of the present invention is composed as follows.

That is, the wafer aligner comprises holding means disposed rotatably for holding a wafer, transfer means for holding the wafer conveyed from a robot and transferring to the holding means, and detecting means for detecting the position of the notch or orientation flat of the wafer during its rotation, whereby the position of the notch or orientation flat of the wafer is matched with the reference rotation position,

in which the transfer means has the wafer holder, and is composed to be rotatable by a specified angle by first rotation drive means, and

the holding means has a wafer gripper elevatable across the wafer holder of the transfer means and is composed to be rotatable by second rotation drive means, and is also composed to be capable of moving the wafer to the upward position capable of rotating the wafer from the wafer holding position of the transfer means by elevating drive means, and to be opened or closed by opening drive means in order to grip or ungrip the edge of the wafer.

According to the present invention, when the wafer conveyed by the robot hand is gripped by the transfer means, the holding means capable of opening and closing ascends or descends to transfer the wafer, and the wafer edge is held by the wafer gripper. When the wafer gripper of the holding means moves up beyond the wafer holder of the transfer means, the wafer is moved to a rotatable position, and then the wafer is turned by one revolution. By gripping and rotating the wafer, the position of the notch or orientation flat of the wafer is detected by the detecting means, and the position of the notch or orientation flat is rotated to the reference rotation position.

In the present invention, therefore, since the wafer is rotated by gripping its edge, the wafer does not slip on the wafer holder of the holding means, and the wafer can be rotated without causing deviation. Accordingly, the positioning precision can be enhanced, and high speed rotation is realized. Moreover, since the reverse side of the wafer is not sucked and held, waste particle does not stick.

Preferably, the holding means should have at least three clamp arms disposed in the radiating line direction from the center of rotation, and each clamp arm should have the wafer gripper, and at least one clamp arm should be composed to be movable in the horizontal direction by the opening drive means.

Therefore, since the holding means has at least three clamp arms, and one clamp arm is composed to be movable in the horizontal direction, the holding means can receive from the transfer means without interfering with the wafer by opening the wafer holder of the clamp arm wider than the outside diameter of the wafer, and can grip the wafer edge securely by closing.

Further, the opening drive means may comprise first cam means having a cam face formed in the vertical direction, and first roller means disposed to as to be engaged with the first cam means and movable along the cam face.

In this configuration, since the opening drive means has the cam face of the first cam means formed in the vertical direction, and the first roller means movable along the cam surface, when the holding means ascends or descends, simultaneously, the first roller means moves in the horizontal direction along the cam face of the first cam means formed in the vertical direction, so that the clamp arms of the holding means can be moved in the horizontal direction along the cam face. Therefore, when the holding means moves to the height position of the wafer, the edge of the wafer can be gripped. Moreover, since the cam face of the first cam means is formed in the vertical direction, the space in the lateral direction is saved, so that an aligner of a compact design can be presented.

If the first rotation drive means is composed to rotate by the portion of shift angle for avoiding overlap between the holding means and transfer means, when the ascending or descending holding means is at a position overlapping with the transfer means, that is, when the holding means having the wafer of which position of notch or orientation flat detected by the detecting means matched with the reference rotation position once moves the transfer means by the portion of rotation to avoid overlap with the holding means by the first rotation drive means if the wafer holder of the holding means and the wafer holder of the transfer means coincide with each other at a same angle position. As a result, when raising the wafer holding unit of the holding means, interference with the wafer holder of the transfer means can be avoided.

Therefore, wafer alignment in one cycle can be controlled without trouble.

Since the first rotation drive means comprises an eccentric cam and an oscillating lever having a cam roller to be engaged with the eccentric cam, that is, the first rotation drive means capable of rotating the transfer means for avoiding overlap between the gripper of the holding means and holder of the transfer means has the eccentric cam and oscillating lever having the cam roller, the oscillating lever can be oscillated by a specified angle by the eccentric cam, and hence the transfer arm can be oscillated by a specified angle to avoid interference of the holding means and transfer means, so that overlap can be avoided in a simple structure.

In other aspect, the wafer aligner of the present invention comprises holding means disposed rotatably for holding a wafer, transfer means for holding the wafer conveyed from a robot and transferring to the holding means, and detecting means for detecting the position of the notch or orientation flat of the wafer during its rotation, whereby the position of the notch or orientation flat of the wafer is matched with the reference rotation position,

in which the holding means has a plurality of wafer grippers for gripping the wafer edge, and at least one wafer gripper is composed to be engaged with the notch or orientation flat of the wafer.

Therefore, at least one position of the holding means for gripping the wafer is engaged with the notch or orientation flat of the wafer, deviation of position due to slipping during rotation of the wafer can be completely eliminated.

More specifically, the wafer mounted on the wafer transfer means is once supported by the holding means, and the holding means is rotated a turn, and the position of the notch or orientation flat is detected by the detecting means, thereby moving the position of the notch or orientation flat to a desired position. At this position, the wafer is transferred again to the transfer means. Later, by rotating the holding means, the wafer gripper capable of being engaged with the notch or orientation flat is moved to a position coinciding with the position of the notch or orientation flat in the peripheral direction, and the holding means is raised to grip the wafer again. At this time, at one wafer gripper, the wafer gripper is engaged with the notch or orientation flat of the wafer, while the wafer edge is gripped by other wafer gripper, and therefore if the wafer rotates together with the holding means, the wafer engaged with the notch or orientation flat is securely gripped by the holding means.

According to the present invention, therefore, since at least one wafer gripper of the holding means is engaged with and grip the notch or orientation flat, when the wafer rotates together with the holding means, slipping between the wafer edge and wafer gripper can be prevented, and deviation is avoided. As a result, the positioning precision can be enhanced and high speed rotation is realized. Further, since the reverse side of the wafer is not held by sucking, waste particles does not stick to the wafer.

Preferably, the transfer means has the wafer holder and is composed to be rotatable by a specified angle by the first rotation drive means, and

the holding means is composed to be rotatable by second rotation drive means, and be also capable of moving the wafer to an upward position capable of rotating the wafer from the wafer holding means of the transfer means by the elevating drive means, and be opened or closed freely by the opening drive means for gripping or ungripping the wafer edge.

That is, at least one wafer gripper to be engaged with the notch or orientation flat of the wafer is moved up and down by the elevating means, and also opened or closed freely by the opening means, and when the detected position of the notch or orientation flat is moved to a desired position to be held by the transfer means, being elevated by the elevating means to support the wafer, the wafer gripper is engaged with the notch or orientation flat by the opening means, so that the wafer can be gripped securely.

Therefore, in the present invention, since at least one wafer gripper of the holding means is engaged with and grips the notch or orientation flat of the wafer, slipping between the wafer edge and wafer gripper can be prevented, and deviation of position can be avoided. As a result, the positioning precision is enhanced and high speed rotation is realized. Further, since the reverse side of the wafer is not held by sucking, waste particle does not stick to the wafer.

In a further aspect, the wafer aligner of the present invention comprises holding means disposed rotatably for holding a wafer, transfer means for holding the wafer conveyed from a robot and transferring to the holding means, and detecting means for detecting the position of the notch or orientation flat of the wafer during its rotation, whereby the position of the notch or orientation flat of the wafer is matched with the reference rotation position,

in which the holding means, after the position of the notch or orientation flat is detected by the detecting means, once moves the position of the notch or orientation flat to a preset preliminary reference position, and further the rotation is controlled so as to coincide with the reference rotation position on the basis of the preliminary reference position.

That is, the wafer being mounted on the wafer transfer means is once held by the holding means, the holding means is rotated a turn and the position of the notch or orientation flat is detected by the detecting means, and the position of the notch or orientation flat is moved to the preset preliminary reference position. At this preliminary reference position, the wafer is transferred again to the transfer means. Later, rotating the holding means, the wafer gripper capable of being engaged with the notch or orientation flat is moved to a position coinciding with the position of the notch or orientation flat in the peripheral direction, or a position 180 deg. opposite to this position, and the holding means is raised to grip the wafer again. The wafer gripped by the holding means is matched with the reference rotation position.

Therefore, in the present invention, for example, when aligning a warped wafer or aligning a wafer of which outside diameter is different from the preset diameter, by temporarily putting on the preliminary reference position, rotation angle deviation can be absorbed, and alignment of high precision is realized.

In a further aspect, the wafer aligner of the present invention comprises holding means disposed rotatably for holding a wafer, transfer means for holding the wafer conveyed from a robot and transferring to the holding means, and detecting means for detecting the position of the notch or orientation flat of the wafer during its rotation, whereby the position of the notch or orientation flat of the wafer is matched with the reference rotation position,

in which the transfer means has two stages of the wafer holder, and is composed to be rotatable by a specified angle by first rotation drive means, and further the holding means is designed to be opened or closed by first opening means so as to ascend and descend between upper position and lower position of the wafer holder, and

the holding means has a wafer gripper ascending and descending between upper position of the wafer holder and lower position of the wafer holder of the transfer means and is rotatable by second rotation drive means, and is also composed to be capable of moving the wafer from the lower position to the upper position in the wafer holding position of the transfer means by elevating drive means, and to be also opened or closed by second opening drive means for gripping or ungripping the wafer edge.

In the wafer aligner having such configuration, when the wafer conveyed by the robot hand is gripped by the transfer means which is designed to open and close freely, the holding means free to open and close ascends or descends to grip the wafer, and the wafer edge is gripped by the wafer gripper, and the wafer gripper of the holding means moves up beyond the wafer holder of the transfer means to move the wafer to a rotatable position, then the wafer is turned by one revolution. By gripping and rotating the wafer, the position of the notch or orientation flat of the wafer is detected by the detecting means, and the position of the notch or orientation flat can be matched with the reference rotation position. Therefore, since the wafer edge is gripped during rotation, slipping of wafer is prevented, so that it can be rotated without deviation, and therefore the positioning precision can be securely enhanced and high speed rotation is realized at the same time.

Since the transfer means has two stages of wafer holder, one wafer holder (for example, upper wafer holder) may be used as buffer stage, and the wafer of which position of notch or orientation flat has been detected waits on the buffer stage, so that the position of notch or orientation flat of wafers can be detected continuously, and the through-put is enhanced.

Further, since the reverse side of the wafer is not held by sucking, waste particles does not stick to the wafer.

In this wafer aligner, the transfer means has at least two wafer holding arms, and the wafer holding arms are movably disposed in approaching and departing direction to and from the axial center by means of the first opening drive means having first cam means and first roller means to be engaged with the cam means, and therefore when the holding means holding the wafer of which position of notch or orientation flat has been detected is moved to the upper buffer stage, the wafer gripper of the holding means may be moved up and down without being interfered by the wafer holder of the transfer means.

### BRIEF DESCRIPTION OF THE DRAWINGS

FIG. 1 is a perspective view showing a conventional wafer aligner.

FIG. 2 is a front view showing a wafer aligner in an embodiment of the present invention.

FIG. 3 is a plan view of the same.

FIG. 4 is a front sectional view showing the aligner excluding the detector in FIG. 2.

FIG. 5 is a sectional view of V-V in FIG. 4.

FIG. 6 is a diagram showing an open state of holding clamper being elevated to gripping position of wafer.

FIG. 7 is a diagram showing a gripping state of wafer by further elevation of holding clamper.

FIG. 8 is a plan view showing an overlapped state of holding clamper and transfer arm.

FIG. 9 is a plan view showing an overlap released state of holding clamper and transfer arm.

FIG. 10 is a plan view showing an aligner in other embodiment for gripping wafer by engagement of wafer notch with engaging pawl.

FIG. 11 is a partial front sectional view showing the aligner in FIG. 10.

FIG. 12 is an explanatory diagram showing angle deviation when gripping wafers of different sizes.

FIG. 13 is a front view showing wafer aligner in a different embodiment having buffer stage.

FIG. 14 is a front sectional view showing the aligner device excluding the detector in FIG. 13.

FIG. 15 is a sectional view of XV-XV in FIG. 14.

FIG. 16 is a diagram showing an open state of holding clamper being elevated to gripping position of wafer.

FIG. 17 is a diagram showing a gripping state of wafer by further elevation of holding clamper.

FIG. 18 is a diagram showing an open state of holding clamper being elevated further to move the wafer above the buffer stage.

FIG. 19 is a diagram showing a mounting state of wafer on buffer stage by lowering of holding clamper from the state in FIG. 18.

FIG. 20 is a diagram showing a state of holding clamper returned to original position by moving from the state in FIG. 19.

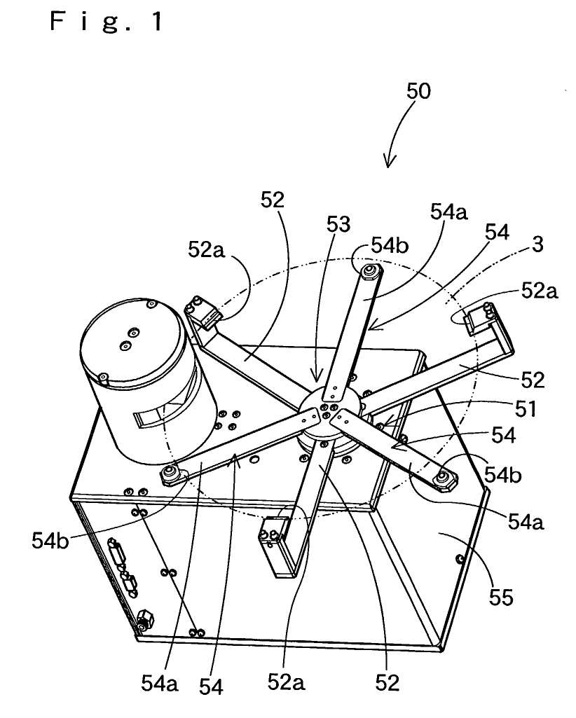

### DESCRIPTION OF THE PREFERRED EMBODIMENTS

Referring now to the drawings, preferred embodiments of the present invention are described below. The wafer aligner of the present invention (hereinafter called aligner) is designed to grip the edge of a wafer transferred by a hand of a robot to enhance the positioning precision, detect the notch or orientation flat formed on the wafer, and adjust to the reference rotation position.

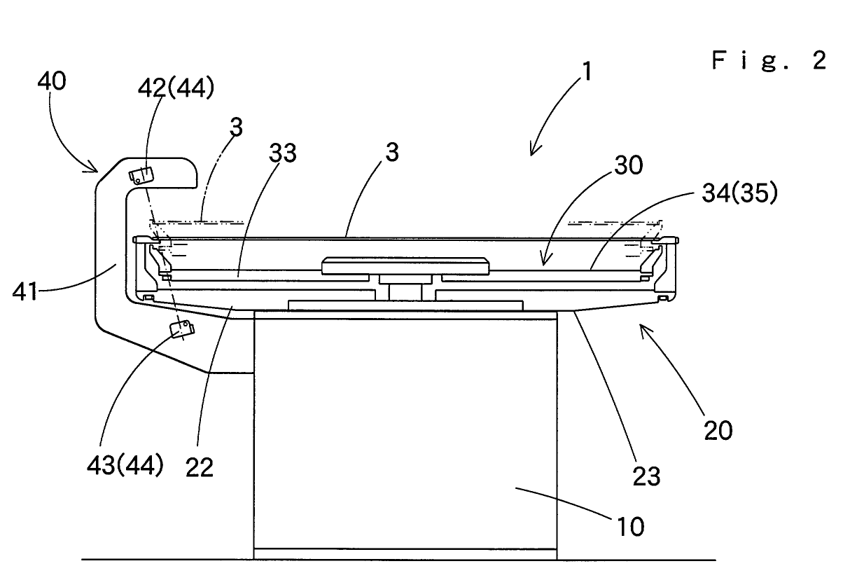

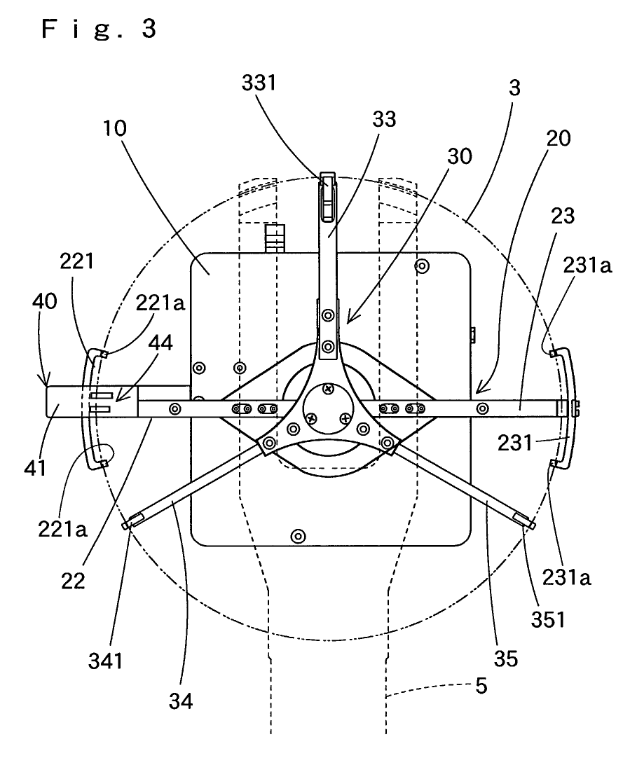

An aligner 1 in a first embodiment comprises, as shown in FIGS. 2 and 3, a machine bed 10, a transfer arm 20 as transfer means for once supporting a wafer 3 transferred by a hand 5 of a robot, a holding clamper 30 as holding means for gripping the wafer 3 held by the transfer arm 20, being composed to be rotatable for detecting the position of notch or orientation flat, and a detector 40 projecting upward from one end of the machine bed 10, as detecting means for detecting the position of notch or orientation flat of the wafer 3 being rotated as being gripped by the holding clamper 30.

The machine bed 10 is a box, and a rotation center shaft 11 affixed to the bottom of the machine bed 10 and projecting from the bottom to above the machine bed 10 is set up in the center thereof, and the transfer arm 20 and holding clamper 30 project from above the machine bed 10.

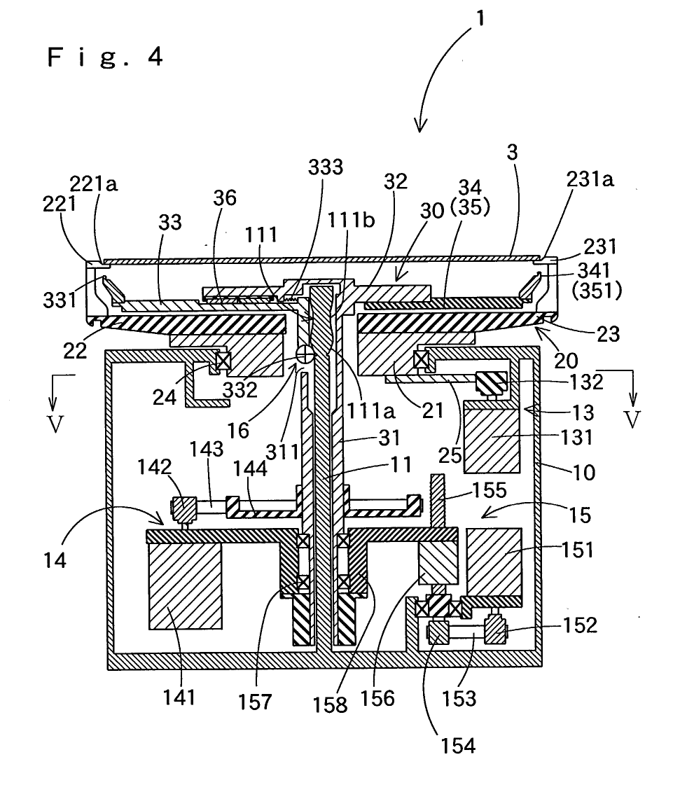

The machine bed 10 incorporates, as shown in FIG. 4, a shift angle rotation drive unit 13 for rotating the transfer arm 20 by a specified angle about the axial center, a rotation drive unit 14 for rotating and driving the holding clamper 30, an elevating drive unit 15 for elevating and lowering the holding clamper 30, and an opening drive unit 16 for opening or closing the holding clamper 30.

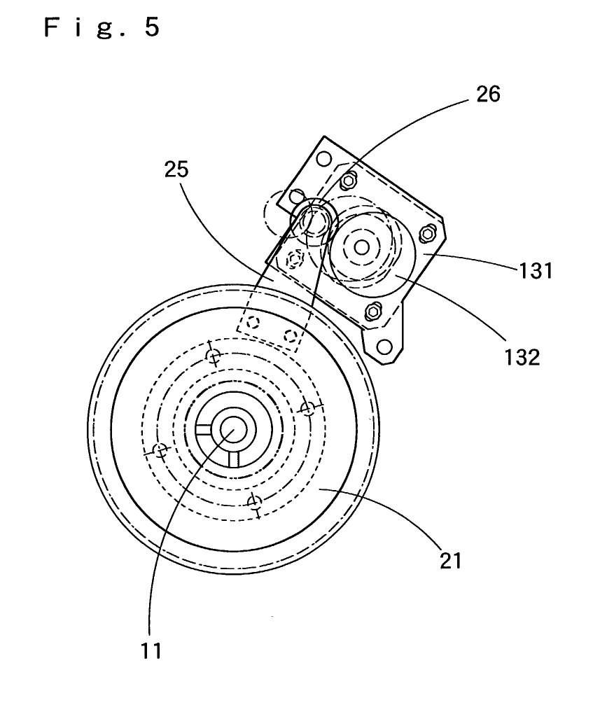

The transfer arm 20 includes a hollow rotary shaft 21 projecting above the machine bed 10, being rotatably supported through a bearing 24, and two L-shaped lower arms 22, 23 mounted on the rotary shaft 21 and extending symmetrically to right and left side, and at the upper ends of each lower arms 22, 23, pawls 221, 231 for mounting the wafer 3 and having two wafer holders 221a, 231a are disposed, and one oscillating lever 25 is disposed at the lower end of the rotary shaft 21, having a cam roller 26 (see FIG. 5) at the leading end.

The holding clamper 30 includes, as shown in FIGS. 3 and 4, a tubular shaft 31 disposed rotatably on the rotation center shaft 11 to cover the rotation center shaft 11, and three upper arms 33, 34, 35 extended from a head 32 extending arms radially in three directions, being formed at the upper end of the tubular shaft 31. The three upper arms 33, 34, 35 have pawls 331, 341, 351 provided at the leading end for gripping the wafer 3 at the upper surface, and one upper arm 33 is disposed movably in the direction of approaching and departing in the horizontal direction with respect to the rotation center shaft 11.

That is, the upper arm 33 is mounted on the head 32 movably through a linear guide 36, and the other two upper arms 34, 35 formed integrally on the head 32, or fixed by screws or the like. The base part of the movable upper arm 33 is inserted into a notch groove 311 formed in one end of the tubular shaft 31, and a cam lower 332 is provided at the lower end, and by applying a coil spring 333 to the head 32, the upper arm 33 is always forced to the head 32 side.

The shift angle rotation drive unit 13 for rotating the transfer arm 20 by a specified angle is driven to avoid interference with the pawls 221, 231 of the lower arms 22, 23 of the transfer arm 20 at the time of elevation of the pawls 331, 341, 351 of the upper arms 33, 34, 35 in the holding clamper 30 when the holding clamper 30 moves to the reference rotation position after detecting the position of notch or orientation flat of the wafer 3, and comprises, as shown in FIG. 5, a motor 131 supported in the machine bed 10, an eccentric cam 132 mounted on the drive shaft of the motor 131, and a cam roller 25 attached to one end of an oscillating lever 25 to be engaged with the outer circumference of the eccentric cam 132.

Therefore, as the motor 131 is driven to put the eccentric cam 132 in rotation, the cam roller 132 engaged with the eccentric cam 132 is moved. The cam roller 132 is attached to one end of the oscillating lever 25 affixed to the rotary shaft 21 at the other end, and therefore the oscillating lever 25 oscillates about the center of rotation, and the rotary shaft 21 is rotated by a specified angle about the center of the rotary shaft 21. This angle shows the evading angle when the transfer arm 20 and holding clamper 30 overlap, and it is preferred to be set at about 5 to 7 degrees.

The rotary drive unit 14 for rotating and driving the holding clamper 30 comprises, as shown in FIG. 4, a motor 141 supported in the machine bed 10, a small pulley 142 mounted on the drive shaft of the motor 141, and a large pulley 144 integrally affixed to the tubular shaft 31 through a belt 143. Therefore, when the motor 141 is driven, the large pulley 144 is put in rotation from the small pulley 142 through the belt 143, and therefore the tubular shaft 31 affixed to the large pulley 144 rotates about the rotation center shaft 11.

The elevating drive unit 15 for driving elevation of the holding clamper 30 comprises a motor 151 supported in the machine bed 10, a drive pulley 152 mounted on the drive shaft of the motor 151, a driven pulley 154 coupled to the drive pulley 152 through a belt 153, a ball screw 155 supported in the machine bed 10 and rotatable along with the rotation of the driven pulley 154, an elevatable nut member 156 screwed into the ball screw 155, an elevating plate 158 having one end affixed to the nut member 156 and having the central part supported in the tubular shaft 31 by way of a bearing 157. The elevating plate 158 and tubular shaft 31 are designed to be elevated and lowered integrally.

Therefore, when the motor 151 is driven, the ball screw 155 is put in rotation by way of the drive pulley 152 and driven pulley 154, and accordingly the nut member 156 is elevated or lowered, thereby elevating or lowering the tubular shaft 31 to move the upper arms 33, 34, 35 up and down.

The opening drive unit 16 for opening and closing the holding clamper 30 comprises a cam face 111 formed in the vertical direction, having a larger end 111a and a smaller end 111b in the upper part of the rotation center shaft 11, and a cam roller 332 of the upper arm 33 engaged with the cam face 111, and the elevating drive unit 15 is composed as a driving source. That is, by driving of the elevating drive unit 15, the tubular shaft 31 is moved up or down, and the upper arm 33 ascends or descends, and along with ascending or descending motion of the upper arm 33, the cam roller 332 ascends or descends at the same time. Since the cam roller 332 moves up and down in the vertical direction along the cam face 111, when engaging with the larger end 111a of the cam face 111, the upper arm 33 moves in a direction of departing from the rotation center shaft 11, and when the cam roller 332 is engaged with the smaller end 111b, it moves in the direction of approaching the rotation center shaft 11, thereby opening or closing.

The detector 40 for detecting the position of the notch or orientation flat of the wafer 3 comprises, as shown in FIG. 2, a pi-shaped bracket 41 having the upper end disposed above the upper arm 33 and lower arm 22, from one end of side of the machine bed 10 through outside of the upper arm 33, and a sensor 44 having a pair of photo projector 42 and photo detector 43 disposed at upper and lower position across the wafer 3 in the bracket 41. At the position for emitting the beam of light to the edge of the wafer 3 from the photo projector 42 of the sensor 44, the photo projector 42 and photo detector 43 are disposed in the bracket 41.

In the aligner 1 having such configuration, the operation is explained below by referring to FIGS. 2 to 9.

The wafer 3 is delivered in and discharged from the wafer aligner 1 of the embodiment by the hand 5 of the conveying robot, and the hand 5 moves in and out from a direction orthogonal to the longitudinal direction of the transfer arm 20 in FIG. 3. The hand 5 transfers the wafer 3 onto the aligner 1 by lowering the wafer 3 from above the pawls 221, 231 of the transfer arm 20 and putting on the wafer holders 221a, 231a of the pawls 221, 231. After delivering the wafer 3 onto the aligner 1, the hand 5 is moved from above the aligner 1 to the robot side not shown. In this state, the upper arms 33, 34, 35 are at the height position shown in FIG. 4, and the cam roller 332 is positioned beneath the larger end 111a of the cam face 111 formed in the rotation center shaft 11.

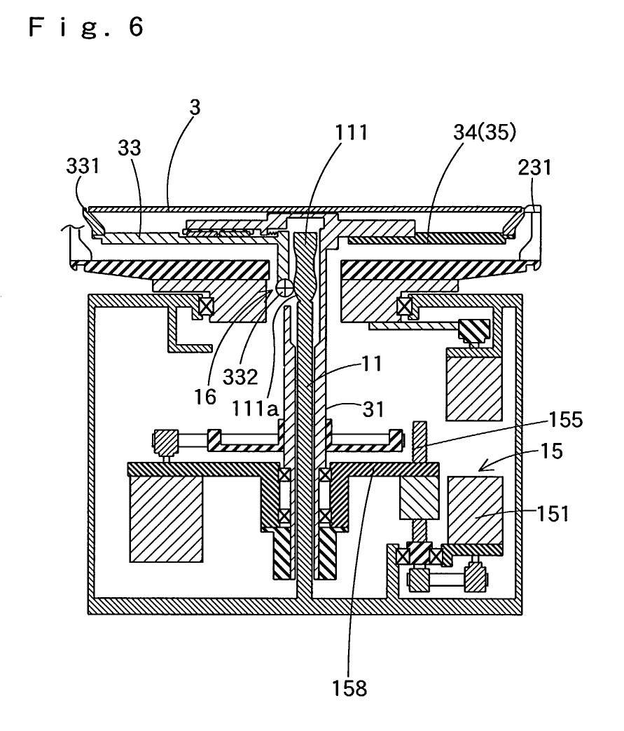

When the wafer 3 is put on the transfer arm 20, the elevating drive unit 15 of the holding clamper 30 is put in operation, and the tubular shaft 31 is moved up along with the nut member 156 engaged with the ball screw 155 and the elevating plate 158. As a result, as shown in FIG. 6, the cam roller 332 moves up toward the larger end 111a of the cam face 111. Consequently, the upper arm 33 moves in a direction of departing from the rotation center shaft 11, and the pawl 331 is moved outward from the edge of the wafer 3, and then the pawl 331 is moved up to the height position of the edge of the wafer 3. The other upper arms 34, 35 move up to the same height position without opening or closing.

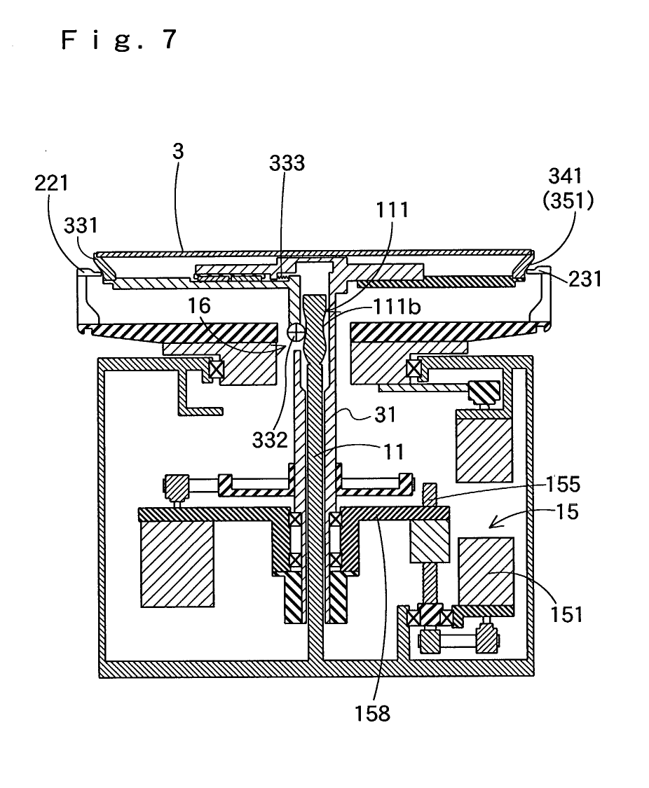

Further, the elevating drive unit 15 is operated, and the cam roller 332 moves up together with the tubular shaft 31, and the cam roller 332 reaches the smaller end 111b of the cam face 111 as shown in FIG. 7, and the upper arms 33, 34, 35 are moved to the upward position of the transfer arm 20, while the upper arm 33 is moved closer to the rotation center shaft 11 side by the thrusting force of the coil spring 333, and the edge of the wafer 3 is abutted against the side of the other upper arms 34, 35, so that the edge of the wafer 3 may be gripped at three points.

The height position of the lifted wafer 3 coincides with the position of the wafer 3 indicated by double dot chain line in FIG. 2, and at this height position, the holding clamper 30 is turned by one revolution.

The tubular shaft 31 is turned by one revolution by operating the drive motor 141 of the rotary drive unit 14 for rotating and driving the holding clamper 30. The wafer 3 gripped by the pawls 331, 341, 351 of the upper arms 33, 34, 35 is turned by one revolution on the machine bed 10 along with one revolution of the tubular shaft 31. The sensor 44 of the detector 40 emits light from the photo projector 42 to the photo detector 43 toward the edge of the wafer 3 simultaneously with rotation of the wafer 3, so that the position of the notch or orientation flat of the wafer 3 is detected.

After the position of the notch or orientation flat is detected, the wafer 3 is rotated by a specified angle by the aforementioned motor 141 as being driven according to the operation by the control device not shown, and the position of the notch or orientation flat is matched with the reference rotation position.

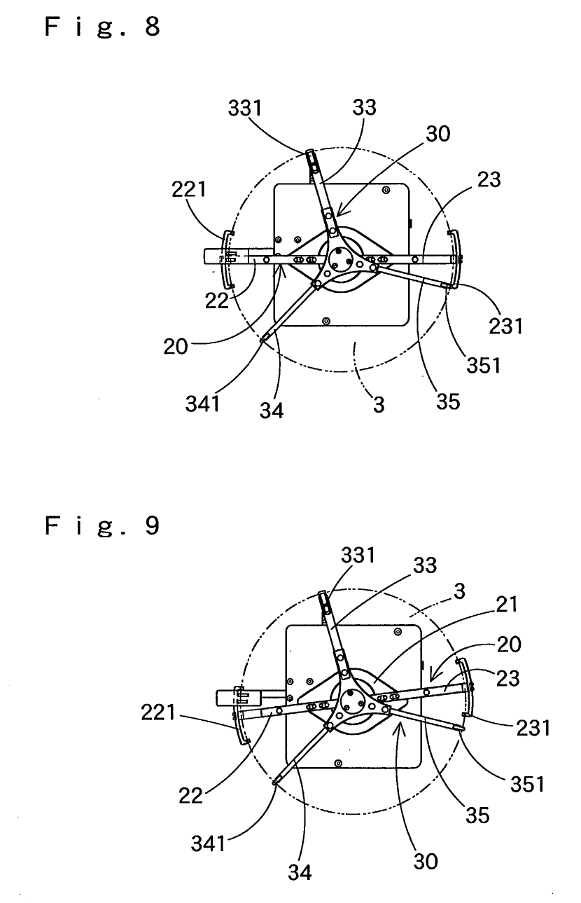

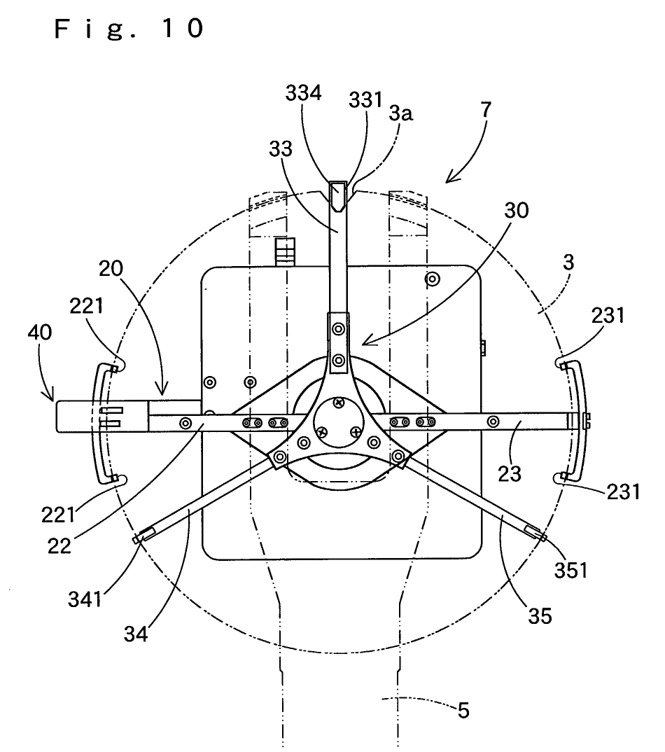

At this time, if any one of pawls 331,341,351 of the upper arms 33, 34, 35 of the holding clamper 30 is at the overlapping position with the pawl 221 or 231 of the lower arm 22 or 23 of the transfer arm 20 as shown in FIG. 8, as shown in FIGS. 4 and 5, the transfer arm 20 is rotated by a specified angle to a position not interfering between the pawl 221 or 231 of the lower arm 22 or 23 and the pawl 331, 341, or 351 of the upper arm 33, 34 or 35. This operation is carried out by the shift angle rotation drive unit 13 of the transfer arm 20. That is, when the motor 131 is operated, the eccentric cam 132 is rotated, and the cam roller 26 is moved by the portion of the eccentric stroke of the eccentric cam 132, and therefore the oscillating lever 25 mounting the cam roller 26 oscillates about the center of rotation as shown in FIG. 9, and the rotary shaft 21 is rotated by 5 to 7 degrees, thereby avoiding overlap between the pawl 221 or 231 of the lower arm 22 or 23 and the pawl 331, 341, or 351 of the upper arm 33, 34, or 35.

When overlap of the transfer arm 20 and holding clamper 30 is avoided, the holding clamper 30 gripping the wafer 3 is lowered, and by opening one upper arm 33, the wafer 3 is put on the pawls 221, 231 of the transfer arm 20.

When the wafer 3 is transferred on the pawls 221, 231 of the transfer arm 20, the hand 5 is moved to the lower position of the wafer, and holds the wafer 3. The wafer 3 is discharged by the hand 5. As a result, one cycle is terminated.

As described herein, the aligner 1 of the embodiment is designed to grip the edge of the wafer 3 by the upper arms 33, 34, 35 when detecting the position of the notch or orientation flat of the wafer, and therefore it is possible to rotate without generating deviation of wafer, and the positioning precision can be enhanced securely and high speed rotation is realized. Further, since the wafer is not held by sucking its reverse side, waste particle does not stick.

Since one upper arm 33 of the holding clamper 30 can be moved in the horizontal direction when ascending or descending, the holding clamper 30 is opened wider than the outside diameter of the wafer 3 to move to a position capable of gripping the wafer 3, thereby realizing transfer, and by closing the edge of the wafer 3 can be gripped securely.

Besides, the opening drive unit 16 comprises the cam face 111 formed in the vertical direction, and the cam roller 332 to be engaged along the cam face 111, and therefore when the holding clamper 30 ascends or descends, it is opened or closed simultaneously, and the holding clamper 30 moves to the height position of the wafer 3, so that the edge of the wafer 3 can be gripped. In addition, since the cam face 111 is formed in the vertical direction, the space in the lateral direction is saved, and the aligner 1 of a compact design can be presented.

Further, when the elevating holding clamper 30 is at a position overlapping with the transfer arm 20, that is, when any one of the pawls 331, 341, 351 of the holding clamper 30 and any one of the pawls 221, 231 of the transfer arm 20 are at a same angle position, the shift angle rotation drive unit 13 is rotated by a specified angle so as to avoid overlap with the transfer arm 20, and therefore the holding clamper 30 ascends or descends at a position not allowing interference between the holding clamper 30 and transfer arm 20, so that the wafer 3 can be held on the transfer arm 20.

At this time, since the shift angle rotation drive unit 13 comprises the oscillating lever 25 having the eccentric cam 132 and cam roller 26, the oscillating lever 25 is oscillated by a specified angle by the eccentric cam 132 so that interference of the holding clamper 30 and transfer arm 20 can be avoided, and overlap can be evaded by a simple structure.

The configuration of the aligner 1 is not limited to the above structure, and the configuration of the shift angle rotation drive unit 13, for example, is not limited to the eccentric cam and cam roller as mentioned above, but it may be realized by other cam mechanism, such as cam mechanism having groove cam and cam roller, or different cam shapes, or cylinder mechanism using cylinder instead of cam mechanism.

The opening drive mechanism 16 may not be limited to the cam mechanism mentioned above, but it may be realized by other cam mechanism or cylinder mechanism.

The elevation drive of the elevating drive unit 15 may not be limited to the ball screw mechanism, but it may be realized by cylinder mechanism, cam mechanism or crank mechanism.

The lower arms 22, 23 for composing the transfer arm 20 may not be limited to two, but three or more may be used as far as formed radially at equal angles. At this time, it is enough when designed to allow the hand to move in and out.

In an aligner 7 of a second embodiment shown in FIG. 10 to FIG. 12, of the upper arms 33, 34, 35 of the foregoing aligner 1, the upper arm 33 moved in the horizontal direction is engaged with the notch 3a or orientation flat of the wafer 3 (hereinafter, the notch 3a is explained).

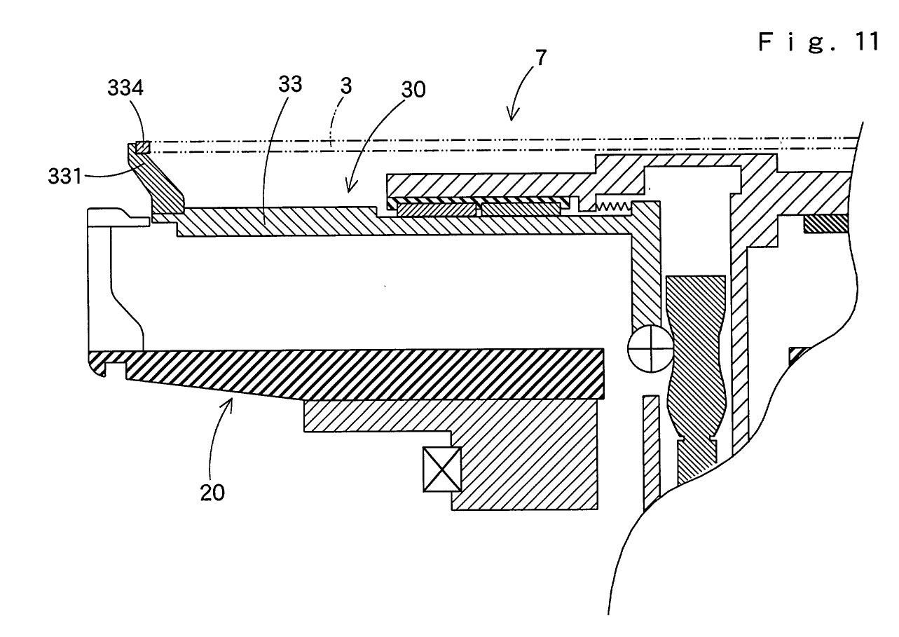

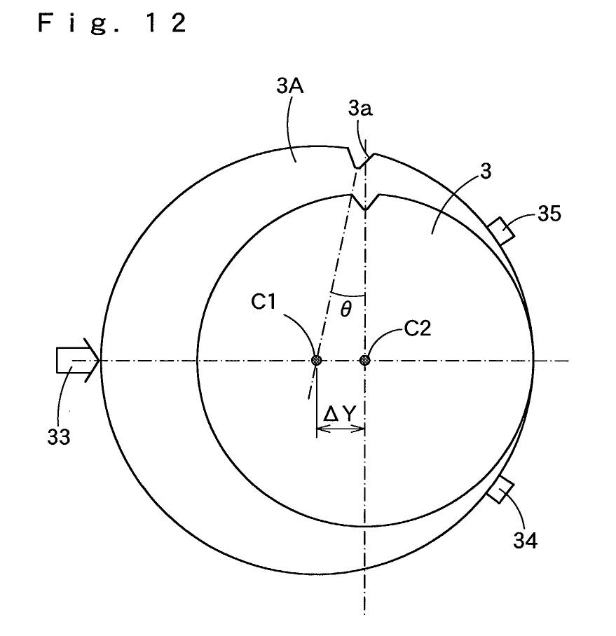

That is, as shown in FIG. 10, the wafer 3 is put on the lower arms 22, 23 of the transfer arm 20 by the hand 5 of the robot, and is gripped by the pawls 221, 231. Three clamper arms 33, 34, 35 are disposed on the holding clamper 20, and one upper arm 33 is designed to be moved in the vertical direction by the elevating drive unit 15 (see FIG. 4) as shown in FIG. 11, and also moved in the horizontal direction by the opening drive unit 16. The upper arm 33 has a pawl 331 for gripping the edge of the wafer 3, and also has an engaging pawl 334 to be affixed with the pawl 331.

The engaging pawl 334, if a V-notch 3a is formed in the wafer 3 as in the illustrated example, has a tapered slope at the leading end so as to be engaged with the notch 3a. Or, when an orientation flat is formed in the wafer 3, the leading end of the engaging pawl 334 is formed in a flat plane.

In the aligner 7 of the embodiment, the wafer put on the transfer arm 20 from the hand 5 of the robot is handled same as in the foregoing embodiment, that is, the holding clamper 30 is once raised by the elevating drive unit 15, and the upper arm 33 is opened or closed by the opening drive unit 16 to support the edge of the wafer 3, and the holding clamper 30 is rotated by one revolution, and the position of the notch 3a is detected by the detector 40.

The detected position of the notch 3a is moved to a specified position as shown in FIG. 10. This position is a position now allowing the upper arms 33, 34, 35 of the holding clamper 30 not to overlap with any one of the pawls 221, 231 of the lower arms 22, 23, and is determined in a direction orthogonal to the transfer arm 20 in the illustrated example. This position is set as a preliminary reference position.

After moving the notch 3a to the preliminary reference position, the wafer 3 is transferred again to the transfer arm 20 at this position. That is, the upper arm 33 of the holding clamper 30 is moved in a direction departing from the wafer 3, and is moved below the transfer arm 20 by the elevating drive unit 15, and the wafer 3 can be transferred from the holding clamper 30 to the transfer arm 20, with the notch position of the waver 3 coinciding with the preliminary reference position.

When the wafer 3 is departed from the holding clamper 30, the holding clamper 30 is rotated and the upper arm 33 is rotated until coinciding with the preliminary reference position. As a result, the upper arm 33 coincides with the notch 3a position in the peripheral direction, and the holding clamper 30 is raised again in this state. Same as in the foregoing embodiment, as the upper arm 33 is raised, it is moved in the horizontal direction toward the notch 3a of the wafer along the cam face 111 of the opening drive unit 16, and therefore the engaging pawl 333 affixed to the upper arm 33 is engaged with the notch 3a.

At this time, the edge of the wafer 3 is supported by the pawls 341, 351 of the upper arms 34, 35 which are not opened or close, and is engaged with the upper arm 33 which is moved, and is also pressed, and therefore the wafer 3 is gripped securely by the clamper 30. In this state, by rotating the notch 3a of the wafer 3 from the preliminary reference position to reference rotation position, it is conveyed by the hand 5 of the robot.

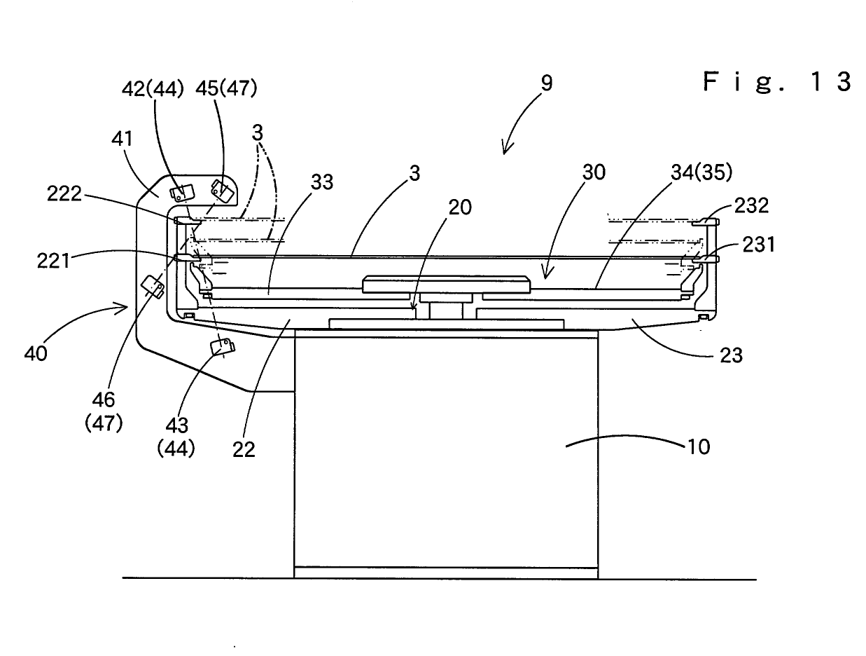

Meanwhile, by moving the position of the notch 3a of the wafer 3 to the preliminary reference position, error in the rotational angle can be eliminated when moving from the preliminary reference position to the reference rotation position. That is, in the state of approximate coincidence between the center of rotation of the rotated wafer 3 and the center of rotation of the holding clamper 30 for gripping the wafer 3, there is almost no rotational angle deviation of the notch 3a due to rotation of the wafer 3. However, as shown in FIG. 12, in the case of a wafer 3A of which outside diameter is different from the preset outside diameter of the wafer 3, when the notch 3a is at a deviated position on the axial line of the upper arm 33, the center of rotation C1 of the wafer 3A and the center of rotation C2 of the holding clamper 30 are deviated by ΔDY, and an angular deviation θ occurs against the notch 3a. Therefore, when rotated to the reference rotation position in this state, the precision is lowered by the portion of the angular deviation θ, and the precision of angular correction of the robot arm is lowered. In this case, therefore, by moving the position of the notch 3a to the position on the axial line of the upper arm 33, the angular deviation θ can be corrected to zero degree. This position is determined as the preliminary reference position.

In this embodiment, as shown in FIG. 10, the position of the notch 3a is moved to a position coinciding on the axial line of the upper arm 33 movable in the horizontal direction. As mentioned above, this position is set as the preliminary reference position. By moving the position of the notch 3a once to the preliminary reference position, the angular deviation θ of the rotation center position of the wafer 3 and the notch 3a is corrected to zero degree, and hence the position of the notch 3a can be moved at a preset angle from the preliminary reference position to the reference rotation direction.

In the aligner 7 shown in FIG. 10, since the upper arm 33 is moved to the position of the notch 3a, the notch 3a of the wafer is moved to the preliminary reference position sequentially, so that angular deviation does not occur.

Setting of preliminary reference position is not limited to the aligner 7 shown in FIG. 10, but may be applied in the aligner 1 shown in FIG. 2, or even in the conventional aligner.

A wafer aligner in a third embodiment of the present invention is explained below. The aligner 9 of the embodiment is similar to the aligner 1 in the first embodiment except for the following points: the pawls of the transfer arm 20 are composed in two stages, that is, pawls 221, 231 of lower stage and pawls 222, 232 of upper stage, and the wafer put on the pawls 222, 232 of the upper stage is designed to wait on the buffer stage. Same parts as in the first embodiment are identified with same reference numerals below.

The aligner 9 of the embodiment is similar to the aligner 1 of the first embodiment, and comprises a machine bed 10, a transfer arm 20, a holding clamper 30, and a detector 40 as detecting means projecting upward from one end of the machine bed 10.

The machine bed 10 is a box, and a rotation center shaft 11 is set up in the center, and the transfer arm 20 and holding clamper 30 are projecting on the machine bed 10.

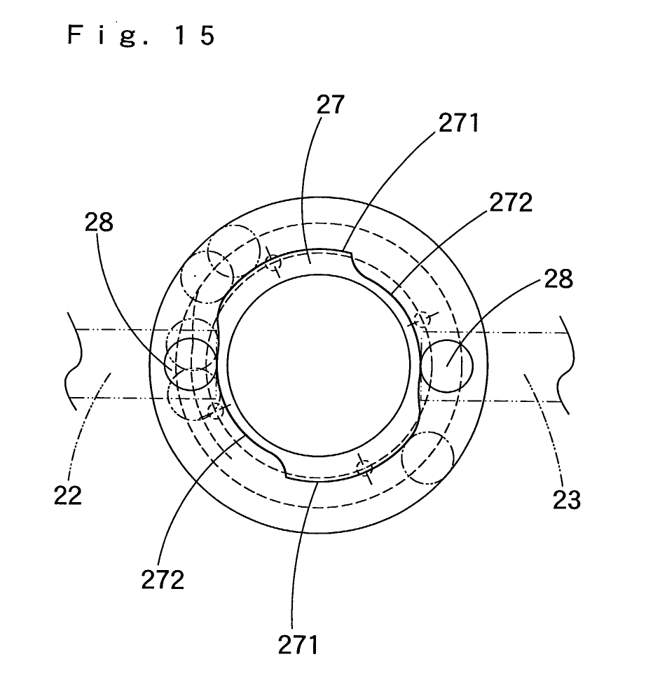

As shown in FIG. 14, the machine bed 10 incorporates an opening drive unit 12 for opening and closing the transfer arm 20, a shift rotation angle drive unit 13 for rotating the transfer arm 20 about the axial center by a specified angle, a rotary drive unit 14 for rotating and driving the holding clamper 30, an elevating drive unit 15 for elevating the holding clamper 30, and opening drive unit 16 for opening and closing the holding clamper 30.

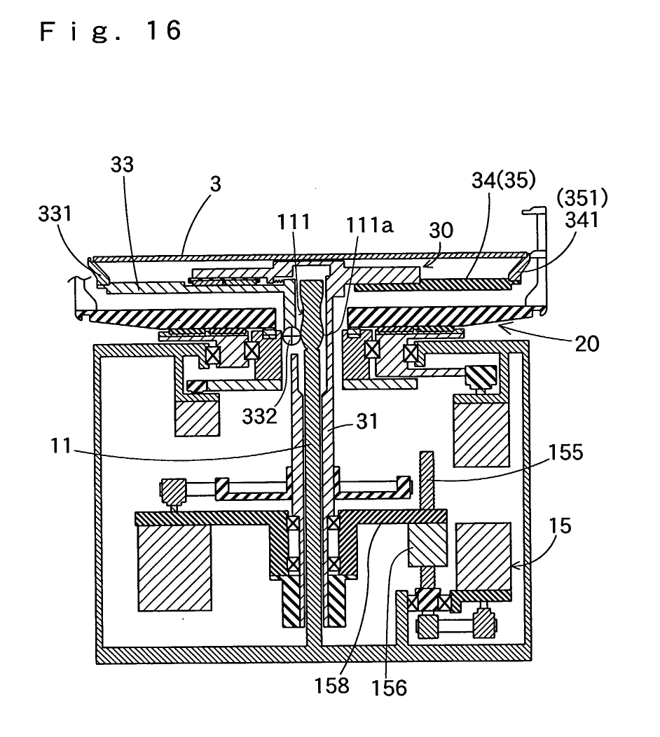

The transfer arm 20 has a rotary shaft 21, and two L-shaped lower arms 22, 23 mounted on the rotary shaft 21 and extending symmetrically to right and left side, and at the upper ends of the lower arms 22, 23, lower pawls 221, 231 having two wafer holders 221a, 231a, and upper pawls 222, 232 having wafer holders 222a, 232a formed as buffer stage of the wafer 3 are disposed, and one oscillating lever 25 is disposed at the lower end of the rotary shaft 21, having a cam roller 26 (see FIG. 5) at the leading end. Further, the lower arms 22, 23 are supported by a pair of cam rollers 28, 28 engaged with a cam member 27 inserted in the rotary shaft 21 as shown in FIG. 15, along with the move of the pair of the cam rollers 28, 28, it is designed to be moved linearly in a direction of approaching and departing with respect to the center of the cam member 27 (rotation center shaft 11).

The holding clamper 30 includes a tubular shaft 31, and three upper arms 33, 34, 35. The three upper arms 33, 34, 35 have pawls 331, 341, 351 provided at the leading end for gripping the wafer 3 at the upper surface, and one upper arm 33 is disposed movably in the direction of approaching and departing in the horizontal direction with respect to the rotation center shaft 11. The detail is as explained in the first embodiment.

The opening drive unit 12 for opening and closing the transfer arm 20 is, as shown in FIGS. 14 and 15, for opening and closing in order to avoid interference of the wafer 3 and upper pawls 222, 232 when raising or lowering the wafer 3 gripped by the upper arms 33, 34, 35 of the holding clamper 30 across the upper pawls 222, 232 as buffer stage, and has a pair of cam rollers 28, 28 engaged with the cam member 27 and symmetrical position of cam member 27, and further comprises a motor 121 for rotating and driving the cam member 27, a small gear 122 mounted on the drive shaft of the motor 121, and a large gear 123 engaged with the small gear 122 and installed in the lower part of the cam member 27. The cam shape of the cam member 27 is formed as shown in FIG. 15, having a pair of bumps 271 and a pair of recesses 272 formed at symmetrical positions with respect to the axial center, and the cam roller 28 is moved by the stroke differential portion in the straight part of the bumps 271 and recesses 272, and accordingly the lower arms 22, 23 are moved.

The shift angle rotation drive unit 13 for rotating the transfer arm 20 by a specified angle is composed same as in the first embodiment as shown in FIG. 5.

The rotary drive unit 14 for rotating and driving the holding clamper 30 is composed same as in the first embodiment as shown in FIG. 3, and comprises a motor 141 supported in the machine bed 10, a small pulley 142 mounted on the drive shaft of the motor 141, and a large pulley 144 integrally affixed to the tubular shaft 31 through a belt 143. Therefore, when the motor 141 is driven, the large pulley 144 is put in rotation from the small pulley 142 through the belt 143, and the tubular shaft 31 affixed to the large pulley 144 rotates about the rotation center shaft 11.

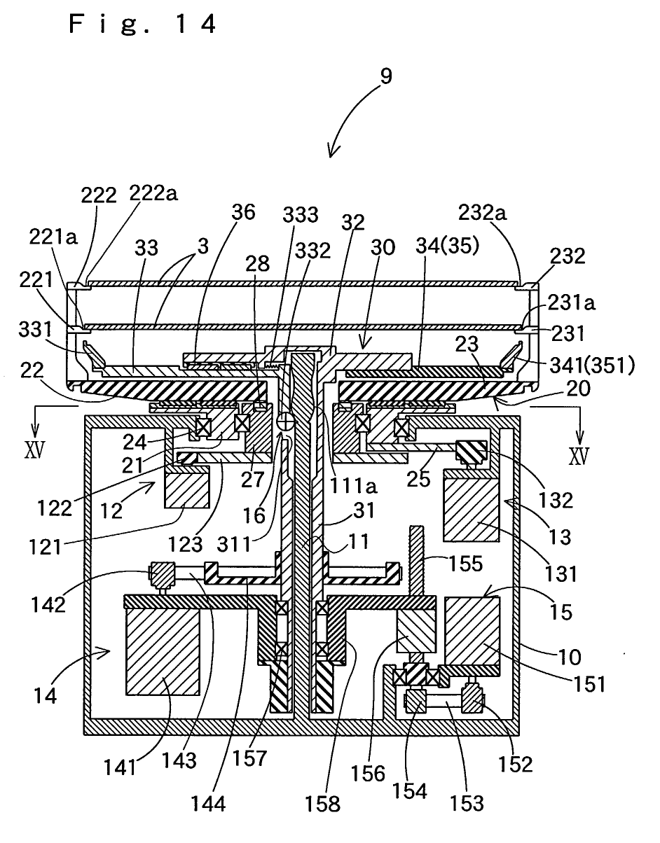

The detector 40 for detecting the position of the notch or orientation flat of the wafer 3 comprises, as shown in FIG. 13, a pi-shaped bracket 41 having the upper end disposed above the upper arm 33 and lower arm 22, from one end of side of the machine bed 10 through outside of the upper arm 33, a position detecting sensor 44 having a pair of photo projector 42 and photo detector 43 disposed at upper and lower position across the wafer 3 in the bracket 41, and a wafer sensor 47 having a photo projector 45 and a photo detector 46 for checking presence or absence of wafer on the buffer stage. At the position for emitting the beam of light to the edge of the wafer 3 in the lower stage from the photo projector 42 of the position detecting sensor 44, the photo projector 42 and photo detector 43 are disposed in the bracket 41, and at the position for emitting the beam of light to the edge of the wafer 3 in the upper stage from the photo projector 45 of the wafer sensor 47, the photo projector 45 and photo detector 46 are disposed in the bracket 41.

In the aligner 9 having such configuration, the operation is explained below by referring to FIGS. 13 to 20.

The wafer 3 is delivered in and discharged from the wafer aligner 9 of the embodiment by the hand 5 of the conveying robot same as in the first embodiment, and the hand 5 moves in and out from a direction orthogonal to the longitudinal direction of the transfer arm 20 (see FIG. 3). The hand 5 transfers the wafer 3 onto the aligner 9 by lowering the wafer 3 from above the lower pawls 221, 231 of the transfer arm 20 and putting on the wafer holders 221a, 231a of the lower pawls 221, 231. After delivering the wafer 3 onto the aligner 9, the hand 5 is moved from above the aligner 9 to the robot side not shown. In this state, the upper arms 33, 34, 35 are at the height position shown in FIG. 14, and the cam roller 332 is positioned beneath the larger end 111a of the cam face 111 formed in the rotation center shaft 11.

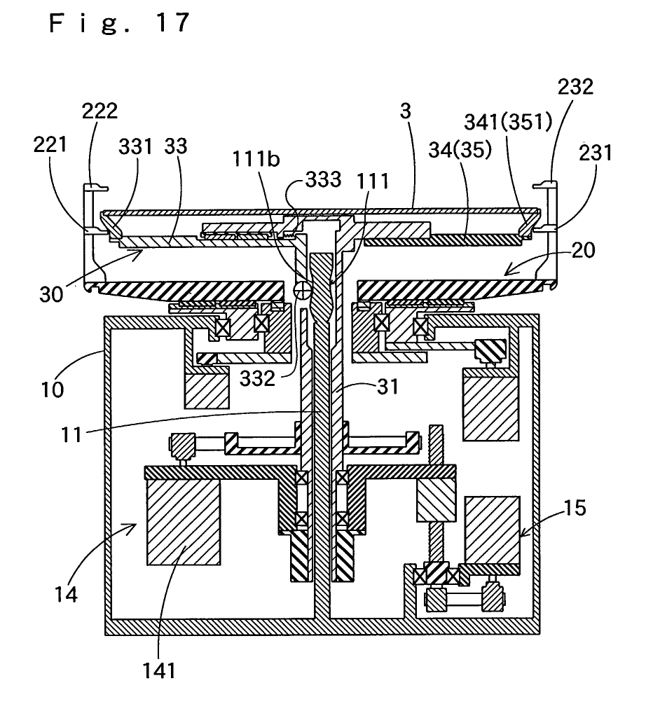

When the wafer 3 is put on the transfer arm 20, the elevating drive unit 15 of the holding clamper 30 is put in operation, and the tubular shaft 31 is moved up along with the nut member 156 engaged with the ball screw 155 and the elevating plate 158. As a result, as shown in FIG. 16, the cam roller 332 moves up toward the larger end 111a of the cam face 111. Consequently, the upper arm 33 moves in a direction of departing from the rotation center shaft 11, and the pawl 331 is moved outward from the edge of the wafer 3, and then the pawl 331 is moved up to the height position of the edge of the wafer 3. The other upper arms 34, 35 move up to the same height position without opening or closing.

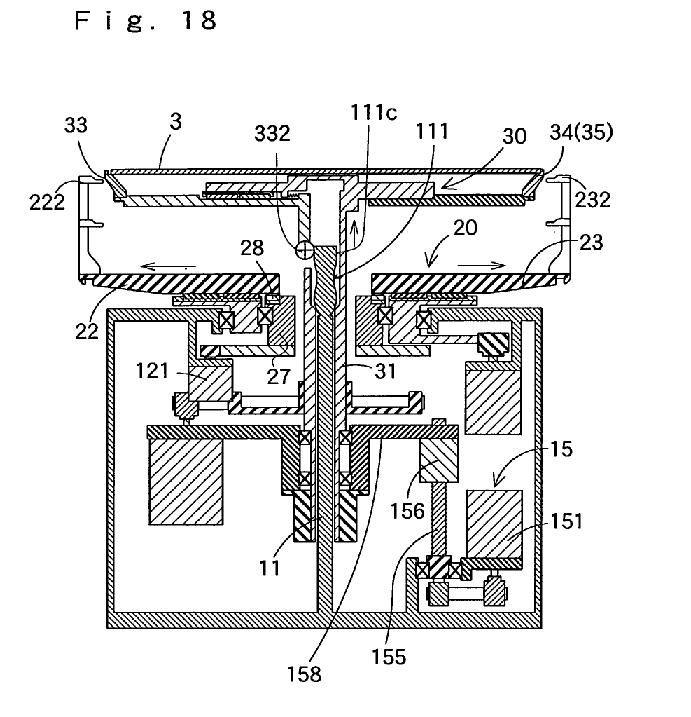

Further, the elevating drive unit 15 is operated, and the cam roller 332 moves up together with the tubular shaft 31, and the cam roller 332 reaches the smaller end 111b of the cam face 111 as shown in FIG. 17, and the upper arms 33, 34, 35 are moved to the upward position of the transfer arm 20, while the upper arm 33 is moved closer to the rotation center shaft 11 side by the thrusting force of the coil spring 333, and the edge of the wafer 3 is abutted against the side of the other upper arms 34, 35, so that the edge of the wafer 3 may be gripped at three points.

The height position of the wafer 3 coincides with the position of the wafer 3 indicated by double dot chain line in FIG. 13, and at this height position, the holding clamper 30 is turned by one revolution.

The tubular shaft 31 is turned by one revolution by operating the drive motor 141 of the rotary drive unit 14 for rotating and driving the holding clamper 30. The wafer 3 gripped by the pawls 331, 341, 351 of the upper arms 33, 34, 35 is turned by one revolution on the machine bed 10 along with one revolution of the tubular shaft 31. In the detector, the position detecting sensor 44 of the detector 40 emits light from the photo projector 42 to the photo detector 43 toward the edge of the wafer 3 simultaneously with rotation of the wafer 3, so that the position of the notch or orientation flat of the wafer 3 is detected, and the wafer sensor 47 emits light from the photo projector 45 to the photo detector 46, so that the presence or absence of the wafer 3 held by the upper pawls 222, 232 can be detected.

After the position of the notch or orientation flat is detected, the wafer 3 is rotated by a specified angle by the aforementioned motor 141 as being driven according to the operation by the control device not shown, from the position of one revolution in order to match the position of the notch or orientation flat with the reference rotation position, and the position of the notch or orientation flat is matched with the reference rotation position.

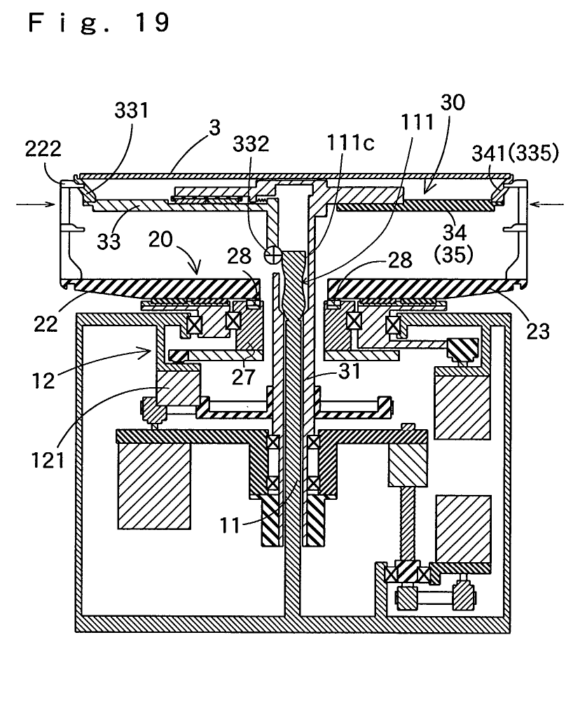

The positioned wafer 3 is further raised, and transferred onto the buffer stage as shown in FIGS. 18 and 19. That is, by the operation of the motor 151 of the elevating drive unit 15, the ball screw 155 is rotated, and by elevation of the nut member 156 and elevating plate 158, the tubular shaft 31 ascends and also the cam roller 332 ascends to be engaged with the upper larger end 111c of the cam face 111. As the cam roller 332 is engaged with the upper larger end 111c, the upper arms 33, 34, 35 of the holding clamper 30 move to the position slightly higher than the upper pawls 222, 232 of the transfer arm 20, and the upper arm 33 departs from the rotation center shaft 11, so that the holding clamper 30 is opened wider than the outside diameter of the wafer 3. However, since the wafer 3 is held in the bottom of the pawl 331 of the upper arm 33, it is not dropped from the holding clamper 30.

When the holding clamper 30 ascends, the transfer arm 20 opens the lower arms 22, 23 by the opening drive unit 12 in order to avoid interference with between holding clamper 30 and the wafer 3 or transfer arm 20. This action is shown in FIG. 15, in which the motor 121 is operated to rotate the cam member 27, and the pair of cam rollers 28, 28 are moved from the recesses 272, 272 of the cam member 27 and engaged with the bumps 271, 271, and the lower arms 22, 23 are moved in a direction departing from the rotation center shaft 11.

When the wafer 3 moves higher above the upper pawls 222, 232 of the transfer arm 20, the cam member 27 is further rotated, and the pair of cam rollers 28, 28 are moved from the bumps 271, 271 of the cam member 27 and engaged with the recesses 272, 272. As a result, as shown in FIG. 19, the upper pawls 222, 232 of the lower arms 22, 23 come closer to the rotation center shaft 11 side and are moved to the position for holding the wafer 3.

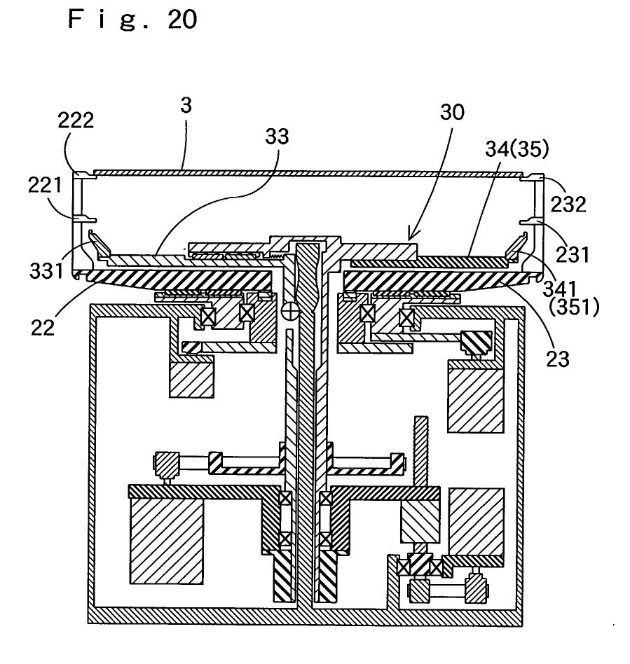

In this state, when the holding clamper 30 is lowered, since the holding clamper 30 is in open state (the upper arm 33 moved outside of the outside diameter of the wafer 3), as shown in FIG. 20, the wafer 3 is transferred onto the upper pawls 222, 232 of the transfer arm 20, and put in the buffer stage. The holding clamper 30 further descends, and the pawls 331, 341, 351 of the upper arms 33, 34, 35 are positioned beneath the lower pawls 221, 231 of the transfer arm 20.

At this time of fall of the holding clamper 30, if any one of the pawls 331, 341, 351 (pawl 351 in the diagram) of the upper arms 33, 34, 35 of the holding clamper 30 is at the overlapping position with the lower pawl 221 or 231 (lower pawl 231 in the diagram) of the lower arm 22 or 23 of the transfer arm 20, the holding clamper 30 interferes with the transfer arm 20 and cannot be lowered, and therefore the transfer arm 20 is rotated by a specified angle to a position not interfering between the lower pawl 221 or 231 of the lower arm 22 or 23 and the pawl 331, 341, or 351 of the upper arm 33, 34 or 35.

This operation is carried out by the shift angle rotation drive unit 13. That is, when the motor 131 is operated, the eccentric cam 132 is rotated, and the cam roller 26 is moved by the portion of the eccentric stroke of the eccentric cam 132, and therefore the oscillating lever 25 mounting the cam roller 26 oscillates about the center of rotation, and the rotary shaft 21 is rotated by 5 to 7 degrees, thereby avoiding overlap between the lower pawl 221 or 231 of the lower arm 22 or 23 and the pawl 331, 341, or 351 of the upper arm 33, 34, or 35.

When overlap of the transfer arm 20 and holding clamper 30 is avoided, the holding clamper 30 is lowered, and waits for a next wafer 3 to be conveyed by the hand 5.

When the next wafer 3 is delivered by the hand 5, and is put on the lower pawls 221, 231 of the transfer arm 20, the hand 5 is moved back to the robot side, and the wafer 3 held on the lower pawls 221, 231 is positioned same as mentioned above. That is, in this state, the wafer 3 finished in positioning is waiting at the buffer stage, and the next wafer 3 is gripped by the holding clamper 30, and the position of the notch or orientation flat of the wafer 3 can be adjusted.

When the next wafer 3 finished in positioning is transferred from the holding clamper 30 to the lower pawls 221, 231 of the transfer arm 20, the hand 5 comes in, and discharges sequentially the wafer 3 (the wafer on the buffer stage) waiting on the upper pawls 222, 232 of the transfer arm 20, and the wafer transferred on the lower pawls 221, 231. A new wafer is sent in again, and the wafer is newly position. Thus, one cycle is terminated.

When discharging the upper and lower wafers finished in positioning by the hand 5, a robot having two stages of hand may be used, so that the two wafers can be discharged simultaneously, and the throughput may be further enhanced.

As described herein, since the aligner 9 of the embodiment is designed to grip and rotate the edge of the wafer 3, it is possible to rotate without generating deviation of the wafer 3, and the positioning precision can be enhanced securely and high speed rotation is realized.

Besides, since the transfer arm 20 has two stages of pawls (lower pawls 221, 231, and upper pawls 222, 232), one pair of pawls (for example, upper pawls 222, 232) may be composed as buffer stage, and with the wafer 3 of which position of the notch or orientation flat waiting at the buffer stage, the position of the notch or orientation flat of the wafer 3 can be detected continuously, and the throughput is enhanced.

Further, since the wafer is not held by sucking its reverse side, waste particle does not stick.

When the holding clamper 30 designed to be elevatable is at a position overlapping with the transfer arm 20, that is, when any one of the pawls 331, 341, 351 of the holding clamper 30 and any one of the lower pawls 221, 231 of the transfer arm 20 are at a coinciding position at a same angle, as the pawls 331, 341, 351 of the holding clamper 30 ascend or descend, they interfere with the lower pawls 221, 231 of the transfer arm 20, and therefore the rotary drive unit 13 moves the transfer arm 20 by a specified angle to avoid overlap, and the holding clamper 30 ascends or descends to hold the wafer 3 on the transfer arm 20 at a position not allowing interference between the pawls 331, 341, 351 of the holding clamper 30 and the lower pawls 221, 231 of the transfer arm 20.

At this time, since the rotary drive unit 13 has the eccentric cam 132 and oscillating lever 25 having cam roller 26, the oscillating lever 25 can be oscillated by a specified angle by the eccentric cam 132, and hence by oscillating the transfer arm 20 by specified angle, interference between the holding clamper 30 and transfer arm 20 can be avoided, so that overlap may be avoided in a simple structure.

With the wafer 3 of which position of the notch or orientation flat is detected being held in the holding clamper 30, when transferring onto the upper pawls 222, 232 (buffer stage), since the transfer arm 20 is designed to open or close the two lower arms 22, 23 by the cam member 27 and pair of cam rollers 28, 28, the wafer 3 can be moved up and down without interfering with the upper pawls 222, 232 of the transfer arm 20.

The holding clamper 30 has at least three upper arms 33, 34, 35, and one upper arm 33 is movable in the horizontal direction, and therefore the holding clamper 30 is opened wider than the outside diameter of the wafer 3 to be moved to a position for gripping the wafer to transfer, and further by closing, the edge of the wafer 3 can be gripped securely.

Moreover, since the opening drive unit 16 comprises the cam face 111 formed in the vertical direction, and the cam roller 332 movable along the cam face 111, when the holding clamper 30 ascends or descends, it is opened or closed simultaneously, and the holding clamper 30 moves to the height position of the wafer 3, so that the edge of the wafer 3 can be gripped. In addition, since the cam face 111 is formed in the vertical direction, the space in the lateral direction is saved, and the aligner 9 of a compact design can be presented.

1. A wafer aligner comprising:
(a) holding means disposed rotatably for holding a wafer, transfer means for holding the wafer conveyed from a robot and transferring to said holding means, and detecting means for detecting the position of the notch or orientation flat of the wafer during its rotation, whereby the position of the notch or orientation flat of the wafer is matched with the reference rotation position,
(b) wherein said transfer means has a wafer holder, and is composed to be rotatable by a specified angle by first rotation drive means, and
(c) said holding means has a wafer gripper elevatable across the wafer holder of the transfer means and is composed to be rotatable by second rotation drive means, and is also composed to be capable of moving the wafer to the upward position capable of rotating the wafer from the wafer holding position of the transfer means by elevating drive means, and to be opened or closed by opening drive means in order to grip or ungrip the edge of the wafer.

2. The wafer aligner of claim 1, wherein said holding means has at least three clamp arms disposed in the radiating line direction from the center of rotation, and each clamp arm has the wafer gripper, and at least one clamp arm is composed to be movable in the horizontal direction by said opening drive means.

3. The wafer aligner of claim 2, wherein said opening drive means comprises first cam means having a cam face formed in the vertical direction, and first roller means disposed so as to be engaged with the first cam means and movable along the cam face.

4. The wafer aligner of claim 1, wherein said first rotation drive means is designed to be rotatable by the portion of a shift angle for avoiding overlap between the holding means and transfer means.

5. The wafer aligner of claim 4, wherein said first rotation drive means includes an eccentric cam, and an oscillating lever having a cam roller to be engaged with said eccentric cam.

6. A wafer aligner comprising:
(a) holding means disposed rotatably for holding a wafer, transfer means for holding the wafer conveyed from a robot and transferring to the holding means, and detecting means for detecting the position of the notch or orientation flat of the wafer during its rotation, whereby the position of the notch or orientation flat of the wafer is matched with the reference rotation position,
(b) wherein said holding means has a plurality of wafer grippers for gripping the wafer edge, and at least one wafer gripper is composed to be engaged with the notch or orientation flat of the wafer.

7. The wafer aligner of claim 6, wherein said transfer means has a wafer holder and is composed to be rotatable by a specified angle by the first rotation drive means, and
said holding means is composed to be rotatable by second rotation drive means, and be also capable of moving the wafer to an upward position capable of rotating the wafer from the wafer holding means of the transfer means by the elevating drive means, and be opened or closed freely by the opening drive means for gripping or ungripping the wafer edge.

8. A wafer aligner comprising:
(a) holding means disposed rotatably for holding a wafer, transfer means for holding the wafer conveyed from a robot and transferring to the holding means, and detecting means for detecting the position of the notch or orientation flat of the wafer during its rotation, whereby the position of the notch or orientation flat of the wafer is matched with the reference rotation position,
(b) wherein said holding means, after the position of the notch or orientation flat is detected by the detecting means, once moves the position of the notch or orientation flat to a preset preliminary reference position, and further the rotation is controlled so as to coincided with the reference rotation position on the basis of the preliminary reference position.

9. A wafer aligner comprising:
(a) holding means disposed rotatably for holding a wafer, transfer means for holding the wafer conveyed from a robot and transferring to the holding means, and detecting means for detecting the position of the notch or orientation flat of the wafer during its rotation, whereby the position of the notch or orientation flat of the wafer is matched with the reference rotation position,
(b) wherein said transfer means has two stages of the wafer holder, and is composed to be rotatable by a specified angle by first rotation drive means,
(c) said holding means is designed to be opened or closed by first opening means so as to ascend and descend between upper position and lower position of the wafer holder,
(d) said holding means has a wafer gripper ascending and descending across the wafer holder of the transfer means and is rotatable by second rotation drive means, and
(e) is also composed to be capable of moving the wafer from the lower position to the upper position in the wafer holding position of the transfer means by elevating drive means, and
(f) to be also opened or closed by second opening drive means for gripping or ungripping the wafer edge.

10. The wafer aligner of claim 9, wherein said first rotation drive means is designed to be rotatable by the portion of a shift angle for avoiding overlap between the holding means and transfer means.

11. The wafer aligner of claim 10, wherein said first rotation drive means includes an eccentric cam, and an oscillating lever having a cam roller to be engaged with said eccentric cam.

12. The wafer aligner of claim 9, wherein said transfer means has at least two wafer holding arms, and said wafer holding arms are movably disposed in approaching and departing direction to and from the axial center by means of the first opening drive means having first cam means and first roller means to be engaged with the first cam means.

13. The wafer aligner of claim 9, wherein said holding means has plural clamp arms disposed in the radiating line direction from the center of rotation, and each clamp arm has a gripper for gripping the edge of the wafer, and at least one clamp arm is composed to be movable in the horizontal direction by said second opening drive means.

14. The wafer aligner of claim 13, wherein said second opening drive means comprises second cam means having a cam part formed in the vertical direction, and second roller means disposed so as to be engaged with the second cam means and movable along the cam part.
